(19) United States
(12) Patent Application Publication
(10) Pub. No.: US 2021/0026850 A1
(43) Pub. Date: Jan. 28, 2021

(54) METHOD, SYSTEM, AND STORAGE MEDIUM FOR PROCESSING DATA SET

(71) Applicant: NEC CORPORATION, Tokyo (JP)

(72) Inventors: Lu FENG, Beijing (CN); Chunchen LIU, Beijing (CN); Wenjuan WEI, Beijing (CN)

(73) Assignee: NEC CORPORATION, Tokyo (JP)

(21) Appl. No.: 17/042,567

(22) PCT Filed: Mar. 29, 2019
(86) PCT No.: PCT/CN2019/080508

§ 371 Date: Sep. 28, 2020

(30) Foreign Application Priority Data
Mar. 29, 2018 (CN) 201810271426.9

(51) Int. Cl. G06F 16/2458; G06N 5/04

(52) U.S. Cl. CPC G06F 16/2465; G06N 5/04

(57) ABSTRACT

Implementations of the present disclosure relate to a method, system and storage medium for processing a data set. According to one example implementation of the present disclosure, a method is provided for processing a data set. The method comprises: collecting a data set of a plurality of samples associated with a plurality of variables, each sample among the plurality of samples comprising data that corresponds to the plurality of variables; building a causal sequence space describing potential causalities between the plurality of variables, a node in the causal sequence space representing a variable with a potential causality in the plurality of variables; performing a forward search and a backward search in the causal sequence space, respectively, so as to obtain a forward causal sequence and a backward causal sequence; and determining the causality between the plurality of variables based on the forward causal sequence and the backward causal sequence. Further, there is provided a corresponding system and computer program product.

### FIELD

Various implementations of the present disclosure relate to a probability model, and more specifically, to a method, system and storage medium for processing a data set.

### BACKGROUND

A probability model is a graphical network model obtained based on probabilistic inference, which refers to obtaining association relationships between a plurality of variables by analyzing collected information that corresponds to these variables. Bayesian networks are probability models proposed for solving problems of uncertainty and incompleteness, which have been widely used in a plurality of areas.

A Bayesian network may describe causalities between a plurality of variables via a directed acyclic graph (DAG) which may comprise nodes representing variables and directed edges and paths representing causalities between these variables. For example, a directed edge pointing from a parent node to its child node may indicate: a variable represented by the parent node and a variable represented by the child node have a direct causality. In another example, a path pointing from one node to another node may indicate: variables represented by the two nodes have an indirect causality. Bayesian networks are applicable to express and analyze uncertain and probabilistic events and may be determined from collected incomplete, inexact or uncertain information corresponding to a plurality of variables.

Various technical solutions have been developed for determining causalities between respective variables in a collected data set based on the data set. However, when the data set includes a large number of variables, these technical solutions might cause a high amount of computation and further cannot obtain the causalities within an acceptable time scope based on limited computing resources.

### SUMMARY

Generally, since causality determination is a basis for subsequent data processing and analysis, how to more effectively determine a causality based on a collected data set will affect the accuracy of subsequent operations to some extent. Therefore, it is desirable to develop and implement a technical solution for processing a data set and determining a causality more accurately and effectively. It is desired that the technical solution may improve the processing efficiency as much as possible, and it is also desired to reduce the amount of computation during a determination of the causality so as to obtain the causality more effectively.

According to a first aspect of the present disclosure, a method is provided for processing a data set. The method comprises: collecting a data set of a plurality of samples associated with a plurality of variables, each sample among the plurality of samples comprising data that corresponds to the plurality of variables; building a causal sequence space describing potential causalities between the plurality of variables, a node in the causal sequence space representing a variable with a potential causality in the plurality of variables; performing a forward search and a backward search in the causal sequence space, respectively, so as to obtain a forward causal sequence and a backward causal sequence; and determining the causality between the plurality of variables based on the forward causal sequence and the backward causal sequence.

According to a second aspect of the present disclosure, a system is provided for processing a data set, the system comprising: one or more processors; a memory coupled to at least one processor of the one or more processors; computer program instructions stored in the memory which, when executed by the at least one processor, cause the system to execute a method for determining a causality between a plurality of variables. The method comprises: collecting a data set of a plurality of samples associated with a plurality of variables, each sample among the plurality of samples comprising data that corresponds to the plurality of variables; building a causal sequence space describing potential causalities in the plurality of variables, a node in the causal sequence space representing a variable with a potential causality between the plurality of variables; performing a forward search and a backward search in the causal sequence space, respectively, so as to obtain a forward causal sequence and a backward causal sequence; and determining the causality between the plurality of variables based on the forward causal sequence and the backward causal sequence.

According to a third aspect of the present disclosure, an apparatus is provided for processing a data set. The apparatus comprises: a collecting module configured to collect a data set of a plurality of samples associated with a plurality of variables, each sample among the plurality of samples comprising data that corresponds to the plurality of variables; a building module configured to build a causal sequence space describing potential causalities in the plurality of variables, a node in the causal sequence space representing a variable with a potential causality between the plurality of variables; a search module configured to perform a forward search and a backward search in the causal sequence space, respectively, so as to obtain a forward causal sequence and a backward causal sequence; and a determining module configured to determine the causality between the plurality of variables based on the forward causal sequence and the backward causal sequence.

According to a fourth aspect of the present disclosure, a computer-readable medium is provided. The computer-readable medium has a computer program stored thereon which, when executed by a processor, implements the method for processing a data set as described in the present disclosure.

By means of the technical solution for processing a data set of the present invention, it is possible to more effectively determine the causality based on a two-way search mode. Moreover, it is possible to reduce the amount of computation during determining the causality, and further to cut down overheads of various computing resources.

### BRIEF DESCRIPTION OF THE DRAWINGS

Through the more detailed description in the accompanying drawings, features, advantages and other aspects of implementations of the present disclosure will become more apparent. Several implementations of the present disclosure are illustrated schematically and are not intended to limit the present invention. In the drawings:

FIG. 1 schematically shows a block diagram of an example computing system which is applicable to implement implementations of the present invention;

FIG. 2 schematically shows a block diagram of a causal sequence space according to one technical solution;

FIG. 3 schematically shows a flowchart of processing a data set based on a forward search and a backward search according to one implementation of the present disclosure;

FIG. 4 schematically shows a flowchart of a method for processing a data set according to one implementation of the present disclosure;

FIG. 5A schematically shows a block diagram for determining search overheads in the forward search according to one implementation of the present disclosure, and FIG. 5B schematically shows a block diagram for determining search overheads in the backward search according to one implementation of the present disclosure;

FIG. 6 schematically shows a block diagram of a forward open set according to one implementation of the present disclosure;

FIG. 7 schematically shows a block diagram for determining a causality between a plurality of variables according to one implementation of the present disclosure; and

FIG. 8 schematically shows a block diagram of an apparatus for processing a data set according to one implementation of the present disclosure.

### DETAILED DESCRIPTION OF IMPLEMENTATIONS

The preferred implementations of the present disclosure will be described in more detail with reference to the drawings. Although the drawings illustrate the preferred implementations of the present disclosure, it should be appreciated that the present disclosure can be implemented in various ways and should not be limited to the implementations explained herein. On the contrary, these implementations are provided to make the present disclosure more thorough and complete and to fully convey the scope of the present disclosure to those skilled in the art.

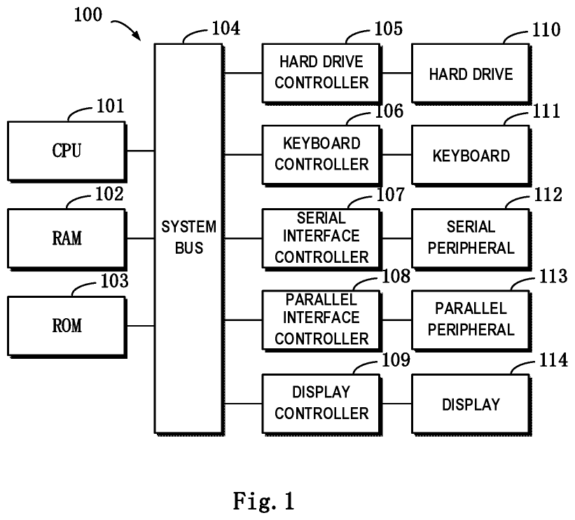

FIG. 1 illustrates an example computing system 100 which is applicable to implement implementations of the present invention. As illustrated in FIG. 1, the computer system 100 may include: CPU (Central Processing Unit) 101, RAM (Random Access Memory) 102, ROM (Read Only Memory) 103, Bus System 104, Hard Drive Controller 105, Keyboard Controller 106, Serial Interface Controller 107, Parallel Interface Controller 108, Display Controller 109, Hard Drive 110, Keyboard 111, Serial Peripheral Equipment 112, Parallel Peripheral Equipment 113 and Display 114. Among the above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105, Keyboard 111 is coupled to Keyboard Controller 106, Serial Peripheral Equipment 112 is coupled to Serial Interface Controller 107, Parallel Peripheral Equipment 113 is coupled to Parallel Interface Controller 108, and Display 114 is coupled to Display Controller 109. It should be understood that the structure as illustrated in FIG. 1 is only for the purpose of example rather than limiting the scope of the present invention. In some cases, some devices may be added to or removed from the computer system 100 based on specific situations.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or one embodiment combining software and hardware aspects that may all generally be referred to herein as a “circuit,” “module” or “system.” Furthermore, in some implementations, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium other than a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wire line, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the scenario related to the remote computer, the remote computer may be connected to the user's computer through any type of network, including a local area network (LAN) or a wide area network (WAN), or a connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or another programmable data processing apparatus to produce a machine, such that the instructions, which execute via the processor of the computer or another programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the functions/acts specified in the flowchart and/or block diagram block or blocks.

The computer program instructions may also be loaded onto a computer, other programmable data processing apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

For the sake of description, first an introduction is given to an example of a specific application environment of the present disclosure. Causality analysis based on a Bayesian network may be applied in various application environments. For example, in an application environment for monitoring whether a control system in a specific area is abnormal, information (e.g., information collected at different time points) corresponding to a plurality of variables (e.g., temperature, humidity, . . . , at a specified location in a specific area and whether the control system is abnormal) may be collected, respectively. There is no limit to the number of variables p, but there may be several variables in a simple application environment, and the number of variables p may reach dozens or even more in a complex application environment.

Data corresponding to variables which is collected at one time point may be stored into one sample (a vector comprising p dimensions), and at this point data collected at n time points may be stored into n samples (here, the n samples may be referred to as a collected data set). Subsequently, the collected data set may be used as input to determine a causality between temperature, humidity and the like at various locations in the area and whether the control system is abnormal.

For the sake of description below, how to determine whether the control system is abnormal is used as a specific example for illustrating a determination of the causality in the context of the present disclosure. According to other implementations of the present disclosure, the technical solution of the present disclosure may be applied in more application environments. For example, in an application environment for determining a causality between sales of a specific product (e.g., beer) and variables (the price of beer, temperature, time, country and other information), a data set comprising sales and various other variables may be collected, and then the causality between sales of beer and other variables may be determined based on the data set.

In another example, in an application environment for determining a causality between a car insurance premium and variables (e.g., the car's brand, model and airbag number, gender and age of the insurance applicant, etc.), a data set comprising the insurance premium and the various other variables may be collected, and then the causality between the insurance premium and the other variables may be determined based on the data set.

In another example, in an application environment for determining a causality between the therapeutic effect of a compound and various properties of the compound in the pharmacy field, a data set comprising various properties of the compound may be collected, and it may be determined based on the data set whether the compound has specified therapeutic effect. Further, implementations of the present disclosure may be further applied in many fields, such as market analysis (e.g., customer satisfaction analysis/analysis of causes of commodity sales trends) and manufacturing.

In the context of the present disclosure, the Bayesian network is used as one specific example of a causality to describe specific details of the present disclosure. Here, the Bayesian network is a graphical probabilistic network model defined based on a DAG. The DAG may be represented by a matrix. Specifically, in the application environment for determining whether the control system is abnormal, suppose there exist the following p variables: temperature, humidity, . . . , whether the control system is abnormal. At this point, a data set comprising n samples may be represented as Table 1.

TABLE 1
Example of Data Set

| Variable x₁ = | Variable x₂ = | | Variable xₚ = being |
|---|---|---|---|
| temperature (° C.) | humidity (%) | . . . | abnormal (true/false) |
| T1 | M1 | . . . | E1 |
| T2 | M2 | . . . | E2 |
| . . . | . . . | . . . | . . . |
| Tn | Mn | . . . | E3 |

As shown in Table 1, the first column “variable x₁=temperature” indicates that the first variable among p variables is “temperature,” that is, temperature values measured at different time points. The second column “variable x₂=humidity” indicates that the second variable among p variables is “humidity,” that is, humidity values measured at different time points. The last column “variable xₚ=being abnormal” indicates that the p^{th} variable among p variables is “being abnormal or not,” that is, whether the control system is abnormal at different time points. Causalities between the above p variables may be represented by a matrix B as below.

$$B = [ \begin{matrix}{β}_{1 , 1} & ⋯ & {β}_{1 , p} \\ ⋮ & ⋱ & ⋮ \\ {β}_{p , 1} & ⋯ & {β}_{p , p}\end{matrix} ]$$

For example, the matrix B is a p-order matrix including p×p elements, each element indicating whether there is a causality between two variables corresponding to a location of the element. Specifically, the variable β_{x,y} in the matrix B represents a causality between the variable x and the variable y among p variables. It should be noted that if locations of two variables differ, then causality also differs. Therefore, β_{x,y} and β_{y,x} represent different causalities. In other words, edges in the directed graph represented by the matrix B have different directions. Moreover, a diagonal in the matrix B represents causalities between each element and itself. However, there is no causality between a specific element and itself, a value of the element at the diagonal should be set to 0.

As seen from the above description, in the Bayesian network, the problem for determining a causality between p variables based on a collected data set may be converted into a procedure for solving a matrix describing causalities between a plurality of elements. By now technical solutions have been proposed to build causal sequences, search for a preferred causal sequence in the built causal sequences and further solve the matrix. At this point, variables in a causal sequence have causalities, and further values of elements corresponding to respective variables in a matrix may be determined.

In order to more clearly describe example implementations of the present disclosure, first an introduction is given to meaning of terms involved herein. In the context of the present disclosure, a causal sequence may comprise a plurality of variables sorted in order. To describe the concept of the causal sequence more clearly, a data set comprising 5 variables will be taken as one example. For example, a data set may comprise 5 variables (variable x₁=temperature, variable x₂=humidity, variable x₃=air quality, variable x₄=light intensity, variable x₅=being abnormal). For example, a causal sequence may be shown as {x₁, x₂, x₄, x₃, x₅}. The causal sequence indicates that the temperature determines the humidity and further the humidity determines whether the control system is abnormal. In this causal sequence, a preceding variable may affect a following variable. For example, “variable x₁=temperature” precedes “variable x₂=humidity,” which indicates that temperature might affect humidity. For another example, “variable x₅=being abnormal” is at the end of the causal sequence, which indicates that all the first four variables might affect whether the control system is abnormal.

According to one technical solution, causal sequences may be randomly selected. However, a maximum of the number of randomly selected causal sequences is usually limited (especially when the value of p is large), or this technical solution will be limited by computing resources of a computing device at runtime. Therefore, it is impossible to obtain an optimal or better causal sequence in case of a limited amount of computation. According to another technical solution, an optimal causal sequence may be searched for in a causal sequence space. However, during searching for the optimal causal sequence, since middle layers of the causal sequence space comprise a large number of state nodes, the search will involve huge computation and require many computing resources and time.

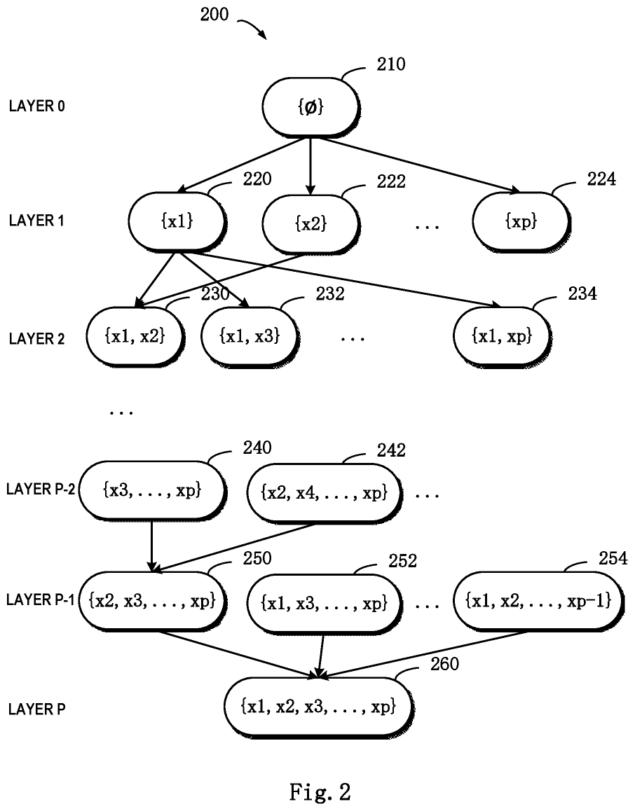

FIG. 2 schematically shows a block diagram 200 of a causal sequence space according to one technical solution. When there are p variables in a data set, a causal sequence space with p+1 layers may be built. As shown in FIG. 2, initially the causal sequence Qₛ is an empty set (as shown by a node 210, which may be referred to as a start node). Subsequently, respective variables may be gradually added to the causal sequence Qₛ. Suppose one variable is added at the first layer, at which point the following p causal sequences may be obtained: {x₁}, {x₂}, . . . , {xₚ} (corresponding to nodes 220, 222, . . . , 224 in FIG. 2, respectively). Next, at the second layer, other variables may be added to the causal sequence represented by each node at the first layer. For example, variables x₂, . . . , xₚ may be added to the causal sequence {x₁} represented by the node 220, respectively, so that nodes 230, 232, . . . , 234 are formed. In the context of the present disclosure, the above procedure of adding another variable to a causal sequence corresponding to a current node so as to form a new node may be referred to as an expansion procedure. It will be understood that nodes at middle layers are not shown in FIG. 2 for the simplicity purpose. The p−2 layer in the causal sequence space may comprise nodes 240, 242, etc., the p−1 layer may comprise nodes 250, 252, . . . , and 254, and the p layer may comprise a node 260 (which may be referred to as a target node).

It will be understood that during carrying out a search along one direction (e.g., from top to bottom), the number of nodes will sharply increase at a middle layer (e.g., at the p/2 layer or (p+1)/2 layer) of the tree structure as shown in FIG. 2. Therefore, a huge amount of computation will be generated during the search.

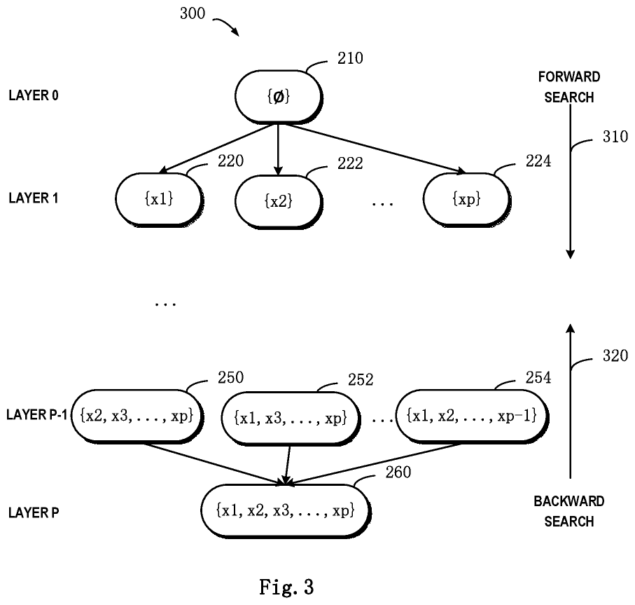

In order to solve the drawbacks in the above technical solutions, according to one implementation of the present disclosure, a method is proposed for processing a data set. Description is presented below to the method with reference to FIG. 3, which schematically shows a block diagram 300 of processing a data set based on a forward search and a backward search. As shown in FIG. 3, in the causal sequence space, a forward search may be performed from the top down as shown by an arrow 310, and a backward search may be performed from the bottom up as shown by an arrow 320. In the implementation as shown by FIG. 3, causal sequences in two directions may be obtained through searching in the causal sequence space along the two directions. Further, a causality between a plurality of variables included in the data set may be obtained based on the obtained two causal sequences. The search along the two directions may stop at a middle layer of the causal sequence space, thereby avoiding huge computation caused by too many nodes included at the middle layer.

According to one implementation of the present disclosure, a data set of a plurality of samples associated with a plurality of variables is collected, each sample of the plurality of samples comprising data that corresponds to the plurality of variables. Subsequently, a causal sequence space describing potential causalities between the plurality of variables is built, a node in the causal sequence space representing a variable with a potential causality in the plurality of variables. Next, a forward search and a backward search are performed in the causal sequence space, respectively, so as to obtain a forward causal sequence and a backward causal sequence. Finally, the causality between the plurality of variables is determined based on the forward causal sequence and the backward causal sequence.

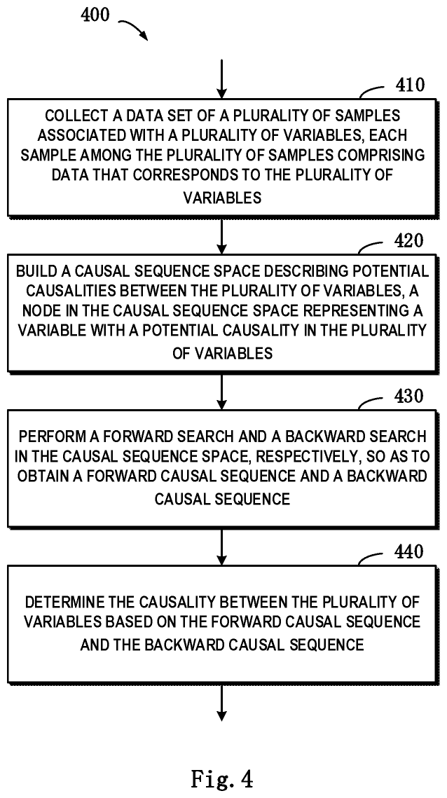

Now with reference to FIG. 4, this figure schematically shows a flowchart of a method 400 for processing a data set according to one implementation of the present disclosure. At block 410, a data set of a plurality of samples associated with a plurality of variables is collected. Each sample of the plurality of samples comprises data corresponding to the plurality of variables. The data set here may be, e.g., the example of data set as shown in Table 1, and a plurality of variables may be, for example, temperature, humidity, . . . , and being abnormal or not as shown in respective columns of Table 1.

At block 420, a causal sequence space describing potential causalities between the plurality of variables is built. A node in the causal sequence space here represents a variable in the plurality of variables that has a potential causality. The causal sequence space as shown in FIG. 2 may be built based on an existing method in the prior art.

At block 430, a forward search and a backward search are performed in the causal sequence space, respectively, so as to obtain a forward causal sequence and a backward causal sequence. In this procedure, the forward search may be performed from the top down, and the backward search may be performed from the bottom up.

At block 440, the causality between the plurality of variables is determined based on the forward causal sequence and the backward causal sequence. In this procedure, the causality between the plurality of variables may be determined by combining the forward causal sequence and the backward causal sequence.

According to one implementation of the present disclosure, a first data a set of a plurality of samples associated with a first portion of the plurality of variables may be collected. Subsequently, a predicted value of a second data set of a plurality of samples associated with a second portion of the plurality of variables may be determined based on the causality and the first data set. In this implementation, the obtained causality may be used for further data processing and analysis. For example, suppose a causality between temperature, humidity, . . . , and being abnormal or not has been obtained based on a historical data set. At this point, since the obtained causality describes an inherent causality between respective variables related to the system, data of variables like temperature and humidity may be collected in real time, and the obtained causality and data collected in real time may be used to predict whether the system is abnormal or not.

More details on how to perform the forward search and the backward search may be described below. According to one example implementation of the present disclosure, priories of respective nodes in a forward open set and a backward open set associated with the forward search and the backward search may be determined respectively. Here the forward open set and the backward open set are sets of nodes which are in the forward search and the backward search but whose child nodes are not yet expanded, a priority of a node representing a possibility that a child node of the node will be expanded.

In the context of the present disclosure, A*Lasso, A*FoBa or other modeling method may be used. At this point, the procedure of searching for an optimal causal sequence may be converted to a problem of determining a shortest path with minimum overheads in the causal sequence space.

Further, the search may be performed in a plurality of rounds. For example, the forward search or the backward search may be performed based on the priorities in each round, so that the forward causal sequence and the backward causal sequence may be obtained. In this implementation, the forward search and the backward search may be “alternately” performed, so that it is possible to avoid expanding too many middle layers in the causal sequence space and further reduce the computation amount for determining causal sequences. It will be understood that the term “alternately” here refers to selecting a search mode from the forward search and the backward search based on the priorities.

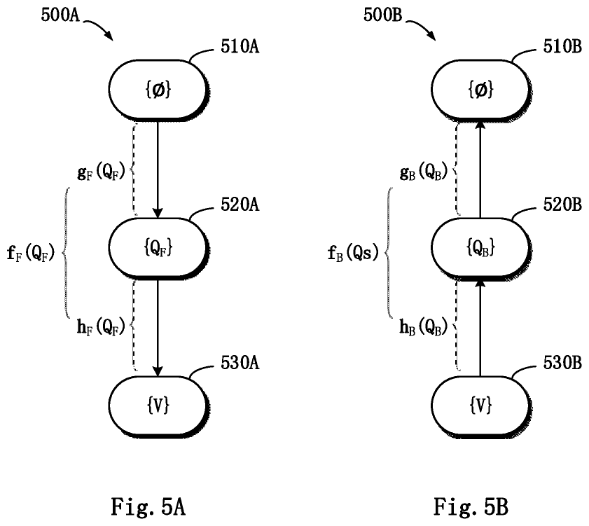

Before an introduction is given on how to calculate the open set and the priority, description is first presented to general principles of determining search overheads with reference to FIGS. 5A and 5B. FIG. 5A schematically shows a block diagram 500A of determining search overheads in the forward search according to one implementation of the present disclosure. It should be noted that based on basic principles of causal inference, suppose a current forward causal sequence is Q_{F}, and a state associated with the forward causal sequence Q_{F} is as shown by a node 520A. Then, overheads of reaching a target node state (e.g., shown by a node 530A, the state associated with a causal sequence comprising all variables) from the state associated with the forward causal sequence Q_{F} may be calculated by formulas below:

$$\begin{matrix}{f}_{F} ( {Q}_{F} ) = {g}_{F} ( {Q}_{F} ) + {h}_{F} ( {Q}_{F} ) & Formula 1 \\ {g}_{F} ( {Q}_{F} ) = {\sum }_{{v}_{j} ∈ {Q}_{F}} LassoScore ( {v}_{j} \vert {Π}_{≺ {v}_{j}}^{{Q}_{F}} ) & Formula 2 \\ {h}_{F} ( {Q}_{F} ) = {\sum }_{{v}_{j} ∈ V \backslash {Q}_{F}} LassoScore ( {v}_{j} \vert V \backslash {v}_{j} ) & Formula 3\end{matrix}$$

In the above formulas, f_{F}(Q_{F}) denotes overheads of reaching a target node state from the state associated with the forward causal sequence Q_{F}, g_{F}(Q_{F}) denotes overheads of reaching the state (as shown by a node 520A) associated with the forward causal sequence Q_{F} from an initial state (an empty set as shown by a node 510A), and h_{F}(Q_{F}) denotes predicted overheads of reaching a target state from the state associated with the forward causal sequence Q_{F}. Note although a modeling approach based on integrated log likelihood and L1 sparsity regularization like A*Lasso is used in this specification, the method proposed by the present disclosure is not limited to this and may also be used for inference learning of other causal models.

FIG. 5B schematically shows a block diagram 500B of determining search overheads in the backward search according to one implementation of the present disclosure. Details about the backward search are similar to the content of Formulas 1 to 3 described with reference to FIG. 5A. In Formulas 4 to 6 to be shown below, f_{B} (Q_{B}) denotes overheads of reaching a start node state from a state associated with the backward causal sequence Q_{B}, g_{B}(Q_{B}) denotes overheads of reaching the state (as shown by a node 520B) associated with the backward causal sequence Q_{B} from an initial state (a universal set as shown by a node 530B), and h_{B}(Q_{B}) denotes predicted overheads of reaching the start node state from the state associated with the forward causal sequence Q_{B}.

$$\begin{matrix}{f}_{B} ( {Q}_{B} ) = {g}_{B} ( {Q}_{B} ) + {h}_{B} ( {Q}_{B} ) & Formula 4 \\ {g}_{B} ( {Q}_{B} ) = {\sum }_{{v}_{j} ∈ V \backslash {Q}_{B}} LassoScore ( {v}_{j} \vert {Q}_{B} Y {Π}_{π {v}_{j}}^{V \backslash {Q}_{F}} ) & Formula 5 \\ {h}_{B} ( {Q}_{B} ) = {\sum }_{{v}_{j} ∈ {Q}_{F}} LassoScore ( {v}_{j} \vert V \backslash {v}_{j} ) & Formula 6\end{matrix}$$

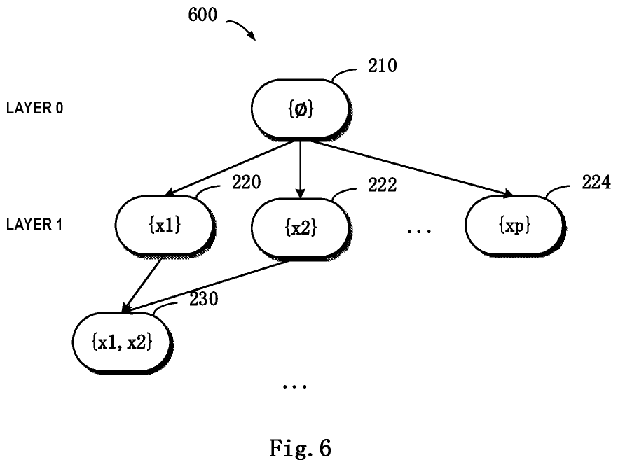

FIG. 6 schematically shows a block diagram 600 of a forward open set according to one implementation of the present disclosure. As depicted, during the forward search procedure, nodes associated with minimum overheads may be constantly searched for based on the above Formulas 1 to 3. For example, suppose at the first layer, overheads associated with the nodes 220 and 222 are minimum, then these two nodes 220 and 222 are in the forward open set and their child nodes will be further expanded (e.g., expanded to form a node 230).

According to one example implementation of the present disclosure, a priority of a node in the forward open set may be determined based on overheads in the forward search of reaching a target node in the causal sequence space via the node and overheads of reaching the node. In the forward search, suppose a node n_{F} corresponding to the forward causal sequence Q_{F} is in the forward open set, then a priority of the node n_{F} may be determined based on a formula below:

pr_{F}(n_{F})=max(f_{F}(Q_{F}),2g_{F}(Q_{F})) Formula 7

In Formula 7, the priority of the node n_{F} may be determined based on a maximum between f_{F} (Q_{F}) and 2g_{F}(Q_{F}). At this point, f_{F}(Q_{F}) and 2g_{F}(Q_{F}) may be determined based on the above Formulas 1 and 2, respectively, and then a larger value may be selected therefrom as the priority of the node n_{F}.

According to one implementation of the present disclosure, a priority of a node in the backward open set may be determined based on overheads of the forward search of reaching a start node in the causal sequence space via the node and overheads of reaching the node. In the backward search, suppose a node n_{B} corresponding to the backward causal sequence Q_{B} is in the backward open set, then a priority of the node n_{B} may be determined based on a formula below:

pr_{B}(n_{B})=max(f_{B}(Q_{B}),2g_{B}(Q_{B})) Formula 8

In Formula 8, the priority of the node n_{B} may be determined based on a maximum between f_{B}(Q_{B}) and 2g_{B}(Q_{B}). At this point, f_{B}(Q_{B}) and 2g_{B}(Q_{B}) may be determined based on the above Formulas 4 and 5, respectively, and then a larger value may be selected therefrom as the priority of the node n_{B}.

According to one example implementation of the present disclosure, where priorities of respective nodes in the forward open set and the backward open set have been determined based on the above Formulas 7 and 8, it may be determined based on a position of a node with the lowest priority among respective nodes whether the forward search or the backward search is to be performed in the next round. Specifically, if it is determined that the node associated with the lowest priority is in the forward open set, then the forward search may be selected. If it is determined that the node associated with the lowest priority is in the backward open set, then the backward search may be selected.

According to one example implementation of the present disclosure, by performing the forward search or the backward search in a plurality of rounds, the forward open set of the forward search will advance from top down in the causal sequence space, and the backward open set of the backward search will advance from bottom up in the causal sequence space. If there is an intersection between the forward open set and the backward open set, this means that a given node in the intersection is in both the forward open set and the backward open set. Search overheads associated with the given node may be calculated, and it may be determined whether the search may stop depending on whether the search overheads satisfy a termination condition. Specifically, regarding the given node in the intersection, if it is determined that the search overheads do not satisfy the termination condition, then a next round of search may be performed in the causal sequence space; otherwise, the search operation will terminate.

According to one example implementation of the present disclosure, the search overheads associated with the given node in the intersection refers to a sum of forward search overheads and backward search overheads. Specifically, the forward search overheads refer to overheads of reaching the given node based on the forward search, and the backward search overheads refer to overheads of reaching the given node based on the backward search. After the forward search overheads and the backward search overheads are determined, the search overheads may be determined based on the sum of the forward search overheads and the backward search overheads.

Suppose a given node n_{C} is in the intersection of the forward open set and the backward open set, a forward causal sequence corresponding to the given node n_{C} is Q_{F}, and a backward causal sequence corresponding to the given node n_{C} is Q_{B}. At this point, the search overheads U may be determined based on a formula below:

U=g_{F}(Q_{F})+g_{B}(Q_{B}) Formula 9

In Formula 9, the overheads g_{F}(Q_{F}) of reaching the given node n_{C} based on the forward search may be determined based on Formula 2, and the overheads g_{B}(Q_{B}) of reaching the given node n_{C} based on the backward search may be determined based on Formula 5.

According to one example implementation of the present disclosure, the termination condition may be determined based on a formula below:

U≤max(C,f_{min F},f_{min B},g_{min F}+g_{min B}) Formula 10

The predetermined termination condition may be determined based on a maximum of each value on the right side of Formula 10: (1) a minimum of a priority of a node in the forward open set and the backward open set, (2) a minimum f_{min F} of overheads in the forward search of reaching a forward search target in the causal sequence space via the given node, (3) a minimum f_{min B} of overheads in the backward search of reaching a backward search target in the causal sequence space via the given node, and (4) a sum g_{min F}+g_{min B} of a minimum g_{min F} of overheads of reaching the given node based on the forward search and a minimum g_{min B} of overheads of reaching the given node based on the backward search. An introduction is given below to the specific meaning of each value.

According to one example implementation of the present disclosure, the minimum C of the priority of the node in the forward open set and the backward open set may be determined based on a formula below:

C=min(pr_{min F},pr_{min B}) Formula 11

In Formula 10, pr_{min F} refers to a minimum of a priority of each node in the forward open set, and the priority of each node in the forward open set may be determined based on the above Formula 7. pr_{min B} refers to a minimum of a priority of each node in the backward open set, and the priority of each node in the backward open set may be determined based on the above Formula 8.

According to one example implementation of the present disclosure, overheads of reaching the forward search target in the causal sequence space via the given node n_{C} in the forward search may be determined based on the above Formula 1, and a minimum of respective overheads may be selected as f_{min F}. Like operations in the forward search, overheads of reaching the backward search target in the causal sequence space via the given node n_{C} in the backward search may be determined based on the above Formula 4, and a minimum of respective overheads may be selected as f_{min B}.

According to one example implementation of the present disclosure, overheads of reaching the given node n_{C} in the forward search may be determined based on the above Formula 2, and a minimum of respective overheads may be selected as g_{min F}. Overheads of reaching the given node n_{C} in the backward search may be determined based on the above Formula 5, and a minimum of respective overheads may be selected as g_{min B}.

A specific value of each variable on the right side of Formula 10 may be determined from the foregoing description. At this point, by comparing U with the maximum of respective variables on the right side of Formula 10, it may be determined whether the search termination condition is satisfied or not. According to one example implementation of the present disclosure, if it is determined that U is less than or equal to the maximum of respective variables on the right side of Formula 10, then the search operation ends. Otherwise, the next round of search will be performed.

According to one example implementation of the present disclosure, after the search terminates, the forward causal sequence and the backward causal sequence may be combined to form a causal sequence. Subsequently, the data set is processed based on the causal sequence, so as to determine the causality between the plurality of variables in the data set. Specifically, a matrix describing the causality between the plurality of variables may be obtained. A problem formula describing the causality may be built based on the data set and the matrix. The problem formula is solved based on the causal sequence, so as to obtain a candidate result of the matrix.

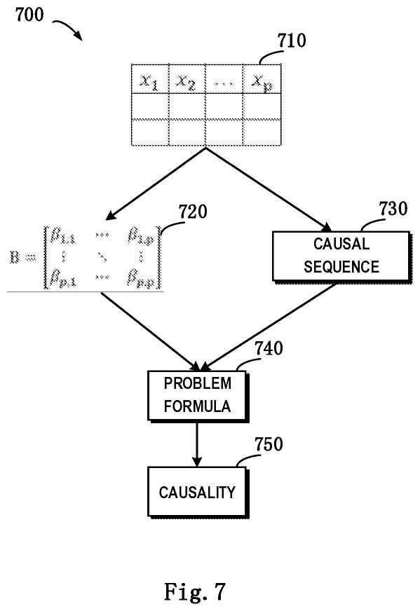

With reference to FIG. 7, description is presented below to more details according to one implementation of the present disclosure. FIG. 7 schematically shows a block diagram 700 of determining a causality between a plurality of variables according to one implementation of the present disclosure. As depicted, a data set 710 (e.g., the data set shown in Table 1) of a plurality of samples (n samples) associated with a plurality of variables may be collected. A matrix 720 (e.g., matrix B) describing a causality between the plurality of variables may be obtained, each sample of the plurality of samples comprising data that corresponds to the plurality of variables. At this point, a value of each element in the built matrix 720 is unknown and may be obtained by solving a problem formula 740. The matrix 720 may comprise p vectors, each of which is as shown by one row in the matrix 720.

For brevity of the description, specific details according to one implementation of the present disclosure will be illustrated by taking a three-dimensional matrix p=3 as a specific example of the matrix 720 describing the causality. At this point, the data set 710 may be represented as Table 2.

TABLE 2
Example of Data Set

| Variable | Variable | Variable x₃ = being |
|---|---|---|
| x₁ = temperature (te | x₂ = humidity (%) | abnormal (true/false) |
| T1 | M1 | E1 |
| T2 | M2 | E2 |
| . . . | . . . | . . . |
| Tn | Mn | E3 |

When p=3, the matrix may be represented as:

$$M = [ \begin{matrix}0 & {β}_{1 , 2} & {β}_{1 , 3} \\ {β}_{2 , 1} & 0 & {β}_{2 , 3} \\ {β}_{3 , 1} & {β}_{3 , 2} & 0\end{matrix} ]$$

At this point, various vectors in matrix B are shown as below:

The first vector: β₁=[0 β_{1,2} β_{1,3];}

The second vector: β₂=[β_{2,1} 0 β_{2,3];}

The third vector: β₃=[β_{3,1} β_{3,2} 0].

In this procedure, the problem formula 740 may be built based on various algorithms that are currently known based on the prior art or will be developed in future. For example, the problem formula may be built based on Formula 12 below:

$${min}_{{β}_{1} , … , {β}_{P}} {\sum }_{j = 1}^{P} {‖ {x}_{j} - {x}_{- j}^{′} {β}_{j} ‖}_{2}^{2} + λ {\sum }_{j = 1}^{P} {‖ {β}_{j} ‖}_{1} \qquad Formula 12$$

Under the condition of using a causal sequence 730 as a constraint, the problem formula 740 may be solved to obtain a causality 750. At this point, the specific value of each element in the matrix 720 may be obtained by solving.

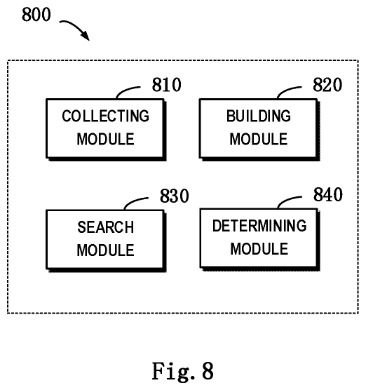

FIG. 8 schematically shows a block diagram of an apparatus 800 for processing a data set according to one implementation of the present disclosure. The apparatus 800 comprises: a collecting module 810 configured to collect a data set of a plurality of samples associated with a plurality of variables, each sample among the plurality of samples comprising data that corresponds to the plurality of variables; a building module 820 configured to build a causal sequence space describing potential causalities between the plurality of variables, a node in the causal sequence space representing a variable with a potential causality in the plurality of variables; a search module 830 configured to perform a forward search and a backward search in the causal sequence space, respectively, so as to obtain a forward causal sequence and a backward causal sequence; and a determining module 840 configured to determine the causality between the plurality of variables based on the forward causal sequence and the backward causal sequence.

According to one example implementation of the present disclosure, the search module 830 comprises: a priority determining module configured to determine respective priorities of respective nodes in a forward open set and a backward open set associated with the forward search and the backward search, respectively, wherein the forward open set and the backward open set are sets of nodes that have been expanded but whose child nodes have not been expanded in the forward causal sequence and the backward causal sequence, respectively; and an executing module configured to perform the forward search or the backward search based on the respective priorities in each round of a plurality of rounds, so as to obtain the forward causal sequence and the backward causal sequence.

According to one example implementation of the present disclosure, the priority determining module comprises: a forward priority determining module configured to determine a priority of the node in the forward open set based on overheads in the forward search for reaching a target node in the causal sequence space via the node and overheads of reaching the node; and a backward priority determining module configured to determine a priority of the node in the backward open set based on overheads of in the backward search for reaching a start node in the causal sequence space and overheads for reaching the node.

According to one example implementation of the present disclosure, the executing module is further configured to: in response to determining that a node associated with the lowest priority is in the forward open set, select to perform the forward search; and in response to determining that a node associated with the lowest priority is in the backward open set, select to perform the backward search.

According to one example implementation of the present disclosure, the search module 830 further comprises a judging module configured to: in response to an intersection existing between the forward open set and the backward open set, with respect to a given node in the intersection, determine search overheads associated with the given node; in response to determining that the search overheads do not satisfy a predetermined termination condition, perform a next round of search in the causal sequence space; and in response to determining that the search overheads satisfy a predetermined termination condition, terminate search in the causal sequence space.

According to one example implementation of the present disclosure, the search module 830 further comprises an overheads determining module configured to: determine forward search overheads and backward search overheads associated with the given node, the forward search overheads and the backward search overheads indicating overheads of reaching the given node based on the forward search and the backward search, respectively; and determine the search overheads based on a sum of the forward search overheads and the backward search overheads.

According to one example implementation of the present disclosure, the predetermined termination condition is determined based on a maximum of: a minimum of priorities of nodes in the forward open set and the backward open set, a minimum of overheads in the forward search of reaching a forward search target in the causal sequence space via g the given node, a minimum of overheads in the backward search of reaching a backward search target in the causal sequence space via the given node, and a sum of a minimum of overheads of reaching the given node based on the forward search and a minimum of overheads of reaching the given node based on the backward search.

According to one example implementation of the present disclosure, the determining module 840 further comprises: a combining module configured to combine the forward causal sequence and the backward causal sequence to form a causal sequence; and a relation determining module configured to process the data set based on the causal sequence, so as to determine the causality between the plurality of variables in the data set.

According to one example implementation of the present disclosure, the collecting module 810 is further configured to collect a first data set of a plurality of samples associated with a first portion of the plurality of variables. The apparatus 800 further comprises a predicting module configured to determine a predicted value of a second data set of a plurality of samples associated with a second portion of the plurality of variables based on the causality and the first data set.

According to one implementation of the present invention, a system is provided for processing a data set, the system comprising: one or more processors; a memory coupled to at least one processor of the one or more processors; computer program instructions stored in the memory which, when executed by the at least one processor, cause the system to execute a method for processing a data set. In the method, a data set of a plurality of samples associated with a plurality of variables may be collected, each sample among the plurality of samples comprising data that corresponds to the plurality of variables. Subsequently, a causal sequence space describing potential causalities between the plurality of variables may be built, a node in the causal sequence space representing a variable with a potential causality in the plurality of variables. Next, a forward search and a backward search are performed in the causal sequence space, respectively, so as to obtain a forward causal sequence and a backward causal sequence. Finally, the causality between the plurality of variables is determined based on the forward causal sequence and the backward causal sequence.

According to one example implementation of the present disclosure, respective priorities of respective nodes in a forward open set and a backward open set associated with the forward search and the backward search may be determined, respectively. At this point, the forward open set and the backward open set are sets of nodes that have been expanded but whose child nodes have not been expanded in the forward causal sequence and the backward causal sequence, respectively. In each round of a plurality of rounds, the forward search or the backward search may be performed based on the respective priorities so as to obtain the forward causal sequence and the backward causal sequence.

According to one example implementation of the present disclosure, in order to determine a priority of a node in the forward open set, a priority of the node in the forward open set may be determined based on overheads in the forward search of reaching a target node in the causal sequence space and overheads of reaching the node.

According to one example implementation of the present disclosure, in order to determine a priority of a node in the backward open set, a priority of the node in the backward open set may be determined based on overheads in the backward search of reaching a start node in the causal sequence space and overheads of reaching the node.

According to one example implementation of the present disclosure, if it is determined that a node associated with the lowest priority is in the forward open set, then the forward search is selected to be performed.

According to one example implementation of the present disclosure, if it is determined that a node associated with the lowest priority is in the backward open set, then the backward search is selected to be performed.

According to one example implementation of the present disclosure, if an intersection exists between the forward open set and the backward open set, with respect to a given node in the intersection, search overheads associated with the given node are determined. Next, it may be determined whether the search overheads satisfy a predetermined termination condition or not. If not, then a next round of search is performed in the causal sequence space; otherwise, search in the causal sequence space terminates.

According to one example implementation of the present disclosure, forward search overheads and backward search overheads associated with the given node may be determined, the forward search overheads and the backward search overheads indicating overheads of reaching the given node based on the forward search and the backward search, respectively. The search overheads may be determined based on a sum of the forward search overheads and the backward search overheads.

According to one example implementation of the present disclosure, the predetermined termination condition is determined based on a maximum of: a minimum of priorities of nodes in the forward open set and the backward open set, a minimum of overheads in the forward search of reaching a forward search target in the causal sequence space via the given node, a minimum of overheads in the backward search of reaching a backward search target in the causal sequence space via the given node, and a sum of a minimum of overheads of reaching the given node based on the forward search and a minimum of overheads of reaching the given node based on the backward search.

According to one example implementation of the present disclosure, the forward causal sequence and the backward causal sequence may be combined to form a causal sequence. Subsequently, the data set may be processed based on the causal sequence, so as to determine the causality between the plurality of variables in the data set.

According to one example implementation of the present disclosure, a first data set of a plurality of samples associated with a first portion of the plurality of variables may be determined. Subsequently, a predicted value of a second data set of a plurality of samples associated with a second portion of the plurality of variables may be determined based on the causality and the first data set.

According to one implementation of the present disclosure, a computer program product is provided. The computer program product is tangibly stored on a non-transitory computer-readable medium and comprises machine-executable instructions which, when executed, cause a machine to implement steps of the method described above.

The various implementations implementing the method of the present invention have been described with reference to the accompanying drawings. Those skilled in the art may appreciate that the method may be implemented in software, hardware or a combination thereof. Moreover, those skilled in the art may appreciate that a device based on the same inventive concept may be provided by implementing respective steps of the method in software, hardware or combination of software and hardware. Even if the device is the same as a general-purpose processing device in hardware structure, the functionality of software contained therein makes the device exhibit distinguishing characteristics over the general-purpose processing device, thereby forming a device according to the various embodiments of the present invention. The device of the present invention comprises several means or modules, which are configured to execute corresponding steps. By reading this specification, those skilled in the art may understand how to write a program to implement actions performed by the means or modules. Since the device and the method are based on the same inventive concept, like or corresponding implementation details also apply to the means or modules corresponding to the method. Since a detailed and complete description has been presented above, details may be omitted below.

The flow charts and block diagrams in the drawings illustrate system architecture, functions and operations that may be implemented by system, method and computer program products according to a plurality of implementations of the present disclosure. In this regard, each block in the flow chart or block diagram can represent a module, a part of program segment or code, where the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order depending on the functions involved. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various implementations of the present disclosure have been described above and the above description is only exemplary rather than exhaustive and is not limited to the implementations of the present disclosure. Many modifications and alterations, without deviating from the scope and spirit of the explained various implementations, are obvious for those skilled in the art. The selection of terms in the text aims to best explain principles and actual applications of each implementation and technical improvements made in the market by each implementation, or enable others of ordinary skill in the art to understand implementations of the present disclosure.

I/We claim:

1. A method for processing a data set, comprising:
collecting a data set of a plurality of samples associated with a plurality of variables, each sample among the plurality of samples comprising data that corresponds to the plurality of variables;
building a causal sequence space describing potential causalities between the plurality of variables, a node in the causal sequence space representing a variable with a potential causality in the plurality of variables;
performing a forward search and a backward search in the causal sequence space, respectively, so as to obtain a forward causal sequence and a backward causal sequence; and
determining the causality between the plurality of variables based on the forward causal sequence and the backward causal sequence.

2. The method of claim 1, wherein performing the forward search and the backward search in the causal sequence space so as to obtain the forward causal sequence and the backward causal sequence comprises:
determining respective priorities of respective nodes in a forward open set and a backward open set associated with the forward search and the backward search, respectively, wherein the forward open set and the backward open set are sets of nodes that have been expanded but whose child nodes have not been expanded in the forward causal sequence and the backward causal sequence, respectively; and
selecting to perform the forward search or the backward search based on the respective priorities in each round of a plurality of rounds, so as to obtain the forward causal sequence and the backward causal sequence.

3. The method of claim 2, wherein,
determining a priority of a node in the forward open set comprises: determining the priority of the node in the forward open set based on overheads in the forward search of reaching a target node in the causal sequence space via the node and overheads of reaching the node; and
determining a priority of a node in the backward open set comprises: determining the priority of the node in the backward open set based on overheads in the backward search of reaching a start node in the causal sequence space via the node and overheads of reaching the node.

4. The method of claim 2, wherein selecting to perform the forward search or the backward search based on the priority comprises:
in response to determining that a node associated with the lowest priority is in the forward open set, selecting to perform the forward search; and
in response to determining that a node associated with the lowest priority is in the backward open set, selecting to perform the backward search.

5. The method of claim 2, wherein selecting to perform the forward search or the backward search based on the respective priorities in each round of the plurality of rounds so as to obtain the forward causal sequence and the backward causal sequence comprises: in response to an intersection existing between the forward open set and the backward open set, with respect to a given node in the intersection,
determining search overheads associated with the given node; and
in response to determining that the search overheads do not satisfy a predetermined termination condition, performing a next round of search in the causal sequence space.

6. The method of claim 5, wherein determining the search overheads associated with the given node comprises:
determining forward search overheads and backward search overheads associated with the given node, the forward search overheads and the backward search overheads indicating overheads of reaching the given node based on the forward search and the backward search, respectively; and
determining the search overheads based on a sum of the forward search overheads and the backward search overheads.

7. The method of claim 5, wherein the predetermined termination condition is determined based on a maximum of:
a minimum of priorities of nodes in the forward open set and the backward open set,
a minimum of overheads in the forward search of reaching a forward search target in the causal sequence space via the given node,
a minimum of overheads in the backward search of reaching a backward search target in the causal sequence space via the given node, and
a sum of a minimum of overheads of reaching the given node based on the forward search and a minimum of overheads of reaching the given node based on the backward search.

8. The method of claim 1, further comprising: in response to determining that the search overheads satisfy a predetermined termination condition, terminating search in the causal sequence space.

9. The method of claim 1, wherein determining the causality between the plurality of variables based on the forward causal sequence and the backward causal sequence comprises:
combining the forward causal sequence and the backward causal sequence to form a causal sequence; and
processing the data set based on the causal sequence, so as to determine the causality between the plurality of variables in the data set.

10. The method of claim 9, further comprising:
collecting a first data set of a plurality of samples associated with a first portion of the plurality of variables; and
determining a predicted value of a second data set of a plurality of samples associated with a second portion of the plurality of variables based on the causality and the first data set.

11. A devise for processing a data set, comprising:
one or more processors configured to:
collect a data set of a plurality of samples associated with a plurality of variables, each sample among the plurality of samples comprising data that corresponds to the plurality of variables;
build a causal sequence space describing potential causalities between the plurality of variables, a node in the causal sequence space representing a variable with a potential causality in the plurality of variables;
perform a forward search and a backward search in the causal sequence space, respectively, so as to obtain a forward causal sequence and a backward causal sequence; and
determine the causality between the plurality of variables based on the forward causal sequence and the backward causal sequence.

12-21. (canceled)

22. A computer program stored thereon which, tangibly stored on a non-transitory computer-readable medium and comprising machine-executable instructions, which, when executed, cause a machine to implement steps of a method according to claim 1.
